(19) United States
(12) Patent Application Publication
(10) Pub. No.: US 2026/0110208 A1
(43) Pub. Date: Apr. 23, 2026

(54) Systems and Methods for Affecting a State Change of a Movable Barrier Operator Based on a Concentration of One or More Gases

(71) Applicant: THE CHAMBERLAIN GROUP LLC, OAK BROOK, IL (US)

(72) Inventor: Eric Chung-Yan Wong, Hoffman Estates, IL (US)

(21) Appl. No.: 18/923,110

(22) Filed: Oct. 22, 2024

(51) Int. Cl. E05F 15/72; E05F 15/73

(52) U.S. Cl. CPC E05F 15/72; E05F 2015/767

(57) ABSTRACT

Systems and methods for affecting a state change of a movable barrier operator based on a concentration of one or more gases are disclosed. The system is configured to perform operations that include detecting the presence of an object within the structure. The system is configured to perform operations that include receiving sensor data that identifies a concentration of a gas within the structure. The system is configured to perform operations that include determining a current state of the movable barrier operator. The system is configured to determine a control instruction to change the state of the movable barrier operator in response to the comparison and the current state of the movable barrier operator. The system is configured to perform operations that include causing communication of the control instruction to the movable barrier operator to change the state of the movable barrier operator.

### FIELD

The present disclosure relates generally to systems and methods for affecting a state change of a movable barrier operator based on a concentration, or concentrations, of one or more gases. More particularly, the present disclosure relates to adjusting the state of the movable barrier operator in response to gas concentrations exceeding a threshold level and the detection of another condition, such as one or more objects within a structure where the concentration is detected.

### BACKGROUND

Opening a movable barrier based on gas concentration presents several technical challenges, including ensuring accurate gas detection with sensors that must perform reliably across varying environmental conditions. The gas concentration data collected by the sensors must be processed in real-time by a computer system that interprets gas concentration (i.e., gas levels) to determine when the movable barrier operator should actuate the movable barrier.

Accordingly, improved systems and methods for affecting a state change of a movable barrier operator based on a concentration of one or more gases are desired in the art. In particular, systems and methods for affecting a state change of a movable barrier operator that performs these tasks without human intervention would be advantageous.

### BRIEF DESCRIPTION

Aspects and advantages of the invention in accordance with the present disclosure will be set forth in part in the following description, or may be obvious from the description, or may be learned through the practice of the technology.

In accordance with one embodiment, a computing system for affecting a state change of a movable barrier operator based on a concentration of one or more gases is provided. The system includes a movable barrier operator associated with a structure; a processor communicatively connected to the movable barrier operator and a sensor; and a non-transitory computer-readable media that stores instructions that, when executed by the processor, cause the computing system to perform operations, the operations comprising: detecting a presence of an object within the structure; receiving, at the processor, sensor data identifying a concentration of a gas within the structure; comparing, by the processor, the identified concentration of the gas with a concentration threshold; determining a current state of the movable barrier operator; determining a control instruction to change the state of the movable barrier operator in response to the comparing and the current state of the movable barrier operator; and causing communication of the control instruction to the movable barrier operator to change the state of the movable barrier operator.

In accordance with another embodiment, a method for affecting a state change of a movable barrier operator based on a concentration of one or more gases is provided. The method comprises: receiving, by a processor communicatively connected to a movable barrier operator and a sensor, image data from an image capture device; processing, by the processor, the image data to detect a presence of a vehicle within a structure; receiving, by the processor, sensor data identifying a concentration of a gas within the structure; comparing, by the processor, the identified concentration of the gas with a concentration threshold; determining, by the processor, a current state of a movable barrier operator that is associated with the structure; determining, by the processor, a control instruction to change the state of the movable barrier operator in response to the comparison and the current state of the movable barrier operator; and causing, by the processor, communication of the control instruction to the movable barrier operator to change the state of the movable barrier operator.

In accordance with another embodiment, a computing system for affecting a state change of a movable barrier operator based on a concentration of one or more gases is provided. The system comprises: a movable barrier operator associated with a structure; one or more processors communicatively connected to the movable barrier operator and a sensor; and one or more non-transitory computer-readable media that collectively store instructions that, when executed by the one or more processors, cause the computing system to perform operations, the operations comprising: receiving, at the processor, image data from an image capture device; processing the image data to determine a presence of a vehicle within the structure, wherein determining the presence of the vehicle further comprises determining a state of the vehicle, wherein processing the image data comprises: training an image processing model using training data; and processing the image data to detect the presence of the vehicle using the trained image processing model; receiving, at the processor, sensor data identifying a concentration of a gas within the structure; comparing, by the processor, the identified concentration of the gas with a concentration threshold; determining a current state of the movable barrier operator; determining a control instruction to change the state of the movable barrier operator in response to the comparing and the current state of the movable barrier operator; and causing communication of the control instruction to the movable barrier operator to change the state of the movable barrier operator.

These and other features, aspects, and advantages of the present invention will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present invention, including the best mode of making and using the present systems and methods, directed to one of ordinary skill in the art, is set forth in the specification, which makes reference to the appended figures, in which:

FIG. 1 is a block diagram of an exemplary system for affecting a state change of a movable barrier operator based on a concentration of one or more gases in accordance with embodiments of the present disclosure;

FIGS. 2A-B are a side view of an exemplary embodiment of a structure in accordance with embodiments of the present disclosure;

FIG. 3 is a flow diagram of an exemplary method for determining a presence of a vehicle within a structure using an image processing model in accordance with embodiments of the present disclosure;

FIG. 4 is a side view of an exemplary embodiment of a structure in accordance with embodiments of the present disclosure; and

FIG. 5 is a flow diagram of an exemplary method for affecting a state change of a movable barrier operator based on a concentration of one or more gases in accordance with embodiments of the present disclosure.

### DETAILED DESCRIPTION

Reference now will be made in detail to embodiments of the present invention, one or more examples of which are illustrated in the drawings. The word “exemplary” is used herein to mean “serving as an example, instance, or illustration.” Any implementation described herein as “exemplary” is not necessarily to be construed as preferred or advantageous over other implementations. Moreover, each example is provided by way of explanation, rather than a limitation of, the technology. In fact, it will be apparent to those skilled in the art that modifications and variations can be made in the present technology without departing from the scope or spirit of the claimed technology. For instance, features illustrated or described as part of one embodiment can be used with another embodiment to yield a still further embodiment. Thus, it is intended that the present disclosure covers such modifications and variations as come within the scope of the appended claims and their equivalents. The detailed description uses numerical and letter designations to refer to features in the drawings. Like or similar designations in the drawings and description have been used to refer to like or similar parts of the invention.

As used herein, the terms “first,” “second,” and “third” may be used interchangeably to distinguish one component from another and are not intended to signify location or importance of the individual components. The singular forms “a,” “an,” and “the” include plural references unless the context clearly dictates otherwise. The terms “coupled,” “fixed,” “attached to,” and the like refer to both direct coupling, fixing, or attaching, as well as indirect coupling, fixing, or attaching through one or more intermediate components or features, unless otherwise specified herein. As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present), and B is false (or not present), A is false (or not present), and B is true (or present), and both A and B are true (or present).

Terms of approximation, such as “about,” “generally,” “approximately,” or “substantially,” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise, or counterclockwise.

As used in this disclosure, the term “function” refers to a situation where one piece of data or one variable determines the value of another. For example, if a second data point is generated as a function of a first data point, the value of the second data point is computed, at least in part, based on the value of the first data point, e.g., through a specific algorithm or process. This relationship can be represented mathematically or programmatically, where a function takes the first data point as an input and produces the second data point as an output, thereby establishing a direct dependency between them.

Benefits, other advantages, and solutions to problems are described below with regard to specific embodiments. However, the benefits, advantages, solutions to problems, and any feature(s) that may cause any benefit, advantage, or solution to occur or become more pronounced are not to be construed as a critical, required, or essential feature of any or all the claims.

Generally, the present disclosure is directed to systems and methods for affecting a state change of a movable barrier operator based on a concentration, or concentrations, of one or more gases at, such as within, a structure. The system and methods disclosed herein are configured to receive sensor data that identifies a concentration of the one or more gases at the structure. Additionally, the system may determine a current state of a movable barrier operator associated with the structure, e.g., using one or more sensors or from information received directly or indirectly from the movable barrier operator. Based on the concentration of the gas within the structure and the state of the movable barrier operator, the systems and methods disclosed herein may control a state of the movable barrier operator.

In some implementations, the system and methods disclosed herein may further leverage one or more sensors, e.g., one or more image capture devices, to identify the presence of one or more objects at the structure. Upon detecting the one or more objects, the sensor(s), or a computing system in communication therewith, may be configured to identify one or more characteristics associated with the one or more objects. For example, the systems and methods disclosed herein may detect the presence of the object within the structure, e.g., within a garage or living environment of the structure. Presence of the object may refer to the state or condition where the object is physically located within a defined space or area of the structure, thereby making the object detectable or observable. For example, detecting the presence of the object may refer to identifying the appearance of the object within image data. By way of non-limiting example, the object may include a person, a vehicle, and/or an animal.

Where the term object refers to a vehicle, detecting the presence of the object may include detecting one or more characteristics associated with the vehicle. These characteristics may include but are not limited to a state (e.g., on or off), an occupancy status (e.g., one passenger, multiple passengers, no passengers, etc.), an orientation (e.g., an angle of the vehicle with respect to the structure), an operation history of one or more of the doors of the vehicle, vehicle dimensions and/or measurements, and the like. A control instruction may be generated and/or modified based on the one or more characteristics of the vehicle.

In an embodiment, the one or more characteristics of the vehicle may include the occupancy status of the vehicle. The occupancy status of the vehicle refers to whether the vehicle is currently occupied by one or more individuals. When a vehicle's occupancy status is described as inhabited, it indicates that there are people or animals present inside of the vehicle. Conversely, if the vehicle's occupancy status is described as uninhabited, it means that there are no people or animals present within the vehicle. In some cases, the control instruction may be modified based on the occupancy status of the vehicle. For example, if the vehicle's occupancy status is identified as “inhabited,” the control instruction might alter the state of the movable barrier operator to an open position if the concentration of the one or more gases surpasses the concentration threshold.

In some implementations, the presence of the object along with the one or more characteristics of the vehicle may be identified based on image data. The image data may be generated by one or more image capture devices located in and/or around the structure. This image data may include a plurality of images of the interior of the structure. The image data consists of a digital array of pixels that captures detailed visual information about the space of the structure. By processing this image data, systems and methods disclosed herein are able to detect the presence and characteristics of one or more objects within the structure. The image data may provide a comprehensive view of the interior environment, allowing for accurate detection of objects based on their visual characteristics and spatial context.

In an embodiment, systems and methods disclosed herein may include determine the presence of the object by processing the image data using an image processing model. The image processing model may employ one or more algorithms to analyze and interpret visual information captured by the image capture device. This image processing model may pre-process the image data to enhance image quality and reduce noise by using techniques such as filtering, normalization, and contrast adjustment. Once the image data is pre-processed, the image processing model may use feature extraction methods to identify and isolate relevant elements within the image, such as objects, vehicles, and people. The image processing model may employ algorithms, such as convolutional neural networks (CNNs), to analyze visual features and detect patterns corresponding to specific categories like objects, vehicles, or people. By comparing these patterns with a dataset of known features, the model can accurately classify and locate different entities within the image. For instance, the image processing model might recognize vehicles by their distinct shapes and sizes, identify people through human silhouette or facial recognition.

In addition to identifying objects, such as vehicles and people, the image processing model can be utilized to determine one or more characteristics of the vehicle, such as its state, occupancy status, and/or orientation. The image processing model may leverage one or more algorithms, such as convolutional neural networks (CNNs) and region-based CNNs (R-CNNs), to determine the vehicle's state by analyzing visual cues like movement patterns and activation indicators. In an embodiment, the image processing model may employ one or more occupancy detection algorithms to identify the presence of individuals based on interior segmentation and thermal imaging. In some embodiments, determining the occupancy status may include tracking the operation history of one or more of the vehicles doors. To track the operation history of the vehicle's doors, the image processing model may employ change detection algorithms and temporal analysis to monitor door positions and movements over time.

In an embodiment, systems and methods disclosed herein receive sensor data identifying a concentration of gas within the structure. Sensor data pertaining to gas concentration within a structure provides precise and quantifiable measurements of specific gaseous compounds present in the environment. Sensor data is acquired using one or more sensors as described herein. The sensors may include specialized gas sensors, which are designed to detect concentrations of gases such as carbon dioxide, carbon monoxide, methane, natural gases, or other relevant substances. The concentration of gas may be expressed in units, such as parts per million (ppm) or parts per billion (ppb), indicating the concentration of the gas within the air. In some implementations, the concentration of gas may be detected by the sensor and transmitted to one or more other system components as a continuous record of readings, capturing variations in gas levels over time.

The concentration of gas may be compared to a concentration threshold. The comparison of the concentration of gas to the concentration threshold involves assessing whether the measured concentration of gas exceeds or falls below a set limit threshold value as established, e.g., for safety, regulatory, or operational purposes. In practice, this comparison is performed by evaluating the sensor data against the threshold value, which represents a critical limit determined based on factors such as safety standards, health guidelines, or system requirements. If the concentration of gas surpasses this threshold value, one or more components of the systems and methods described herein may trigger an alert or initiate corrective actions, such as affecting a state change of the movable barrier operator. Conversely, if the concentration is below the threshold value, the environment is within acceptable limits.

In an embodiment, the systems and methods disclosed herein determine a current state of the movable barrier operator. The current state of the movable barrier operator refers to its present mode of operation concerning the movable barrier. The movable barrier operator can exist in one of several distinct states, each corresponding to a specific function or condition affecting the actuation of the movable barrier. For example, the state of the movable barrier operator indicates whether the movable barrier operator currently has the associated movable barrier in an open position, a closed position, and/or the various degrees of being partially open/closed. For example, if the movable barrier is in the open position, the movable barrier operator has actuated the movable barrier to the open position, whereas in the closed state, the movable barrier operator has actuated the movable barrier to the closed position.

In an embodiment, systems and methods disclosed herein determine a control instruction to change the state of the movable barrier operator based on the comparison of the concentration of gas to the concentration threshold value and/or based on the current state of the movable barrier operator. Determining the control instruction for the movable barrier operator can involve integrating (applying) data from two or more data points. A first data point may include a comparison of the concentration of the gas to the concentration threshold value to determine if the detected concentration exceeds or falls below acceptable levels. A second data point may include information related to the current state of the movable barrier operator. The second data point may include an evaluation of whether the movable barrier operator is in an open position, closed position, and the like. The control instruction may be formulated based on the combined information. For example, if the gas concentration exceeds the threshold value and the movable barrier operator is currently in the closed position, the control instruction might cause the movable barrier operator to initiate the movement of the movable barrier to a position that mitigates the hazardous gas levels, such as opening the movable barrier to ventilate the area. Conversely, if the gas concentration is within safe limits but the movable barrier operator is currently in the closed position, the control instruction may maintain the state of the movable barrier operator or close the movable barrier.

With reference now to the Figures, example embodiments of the present disclosure will be discussed in further detail.

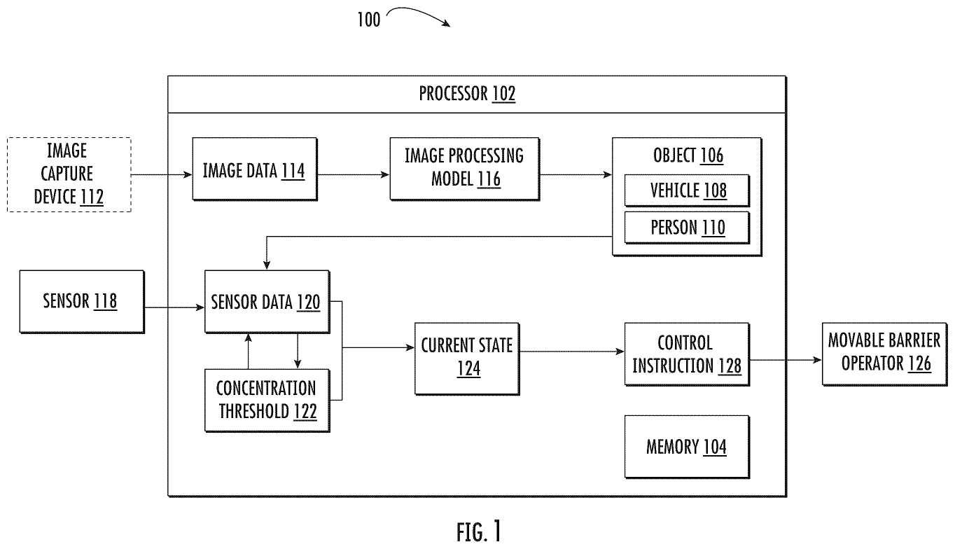

FIG. 1 depicts a block diagram of an exemplary system 100 for affecting a state change of a movable barrier operator based on a concentration, or concentrations, of one or more gases. System 100 includes one or more processors 102 that can be utilized to perform one or more operations. The one or more processors 102 can include any suitable processing device (e.g., a processor core, a microprocessor, an ASIC, a FPGA, a controller, a microcontroller, etc.) and can be one processor or a plurality of processors that are operatively connected. The one or more processors 102 can perform operations in series and/or in parallel. The one or more processors 102 may be dedicated to a particular computing device and/or may be utilized by a plurality of devices to perform processing tasks. In an embodiment, processor 102 could be situated within each of these various computing devices, such as the vehicle control system, infotainment system, navigation system, electronic control units (ECUs), remote computing devices, user device, and the like. One or more of these computing devices may be employed to handle specific processing tasks and operations.

Processor 102 may be designed and/or configured to perform any method, method step, or sequence of method steps in any embodiment described in this disclosure, in any order and with any degree of repetition. For instance, processor 102 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. This may be used to train, refine, or otherwise improve any algorithm, image processing model, machine learning model, neural network, and the like mentioned herein.

Processor 102 may include a single computing device operating independently, or may include two or more computing devices operating in concert, in parallel, sequentially or the like; two or more computing devices may be included together in a single computing device or in two or more computing devices. Processor 102 may include but is not limited to, for example, a computing device or cluster of computing devices in a first location and a second computing device or cluster of computing devices in a second location. Processor 102 may include one or more computing devices dedicated to data storage, security, distribution of traffic for load balancing, and the like. Processor 102 may distribute one or more operations as described below across a plurality of computing devices, which may operate in parallel, in series, redundantly, or in any other manner used for distribution of tasks or memory between computing devices.

System 100 may include memory 104 which can store data and/or instructions. Memory 104 can include one or more non-transitory computer-readable storage mediums, such as RAM, ROM, EEPROM, EPROM, flash memory devices, magnetic disks, etc., and combinations thereof. The data can include user data, application data, operating system data, etc. The data can include text data, image data, audio data, statistical data, latent encoding data, etc. The instructions can include instructions that when executed by one or more of the processors 102 may cause system 100 to perform operations as described herein.

Memory 104 may store data and/or instructions associated with one or more applications. The one or more applications can include native, factory-set applications and/or downloaded applications. The applications may include one or more messaging applications, one or more image capture applications, one or more social media applications, one or more productivity applications, one or more map applications, one or more device management applications, one or more browser applications, and the like. In some implementations, the applications can include one or more applications communicatively connected to one or more server computing systems for providing access to a platform. For example, the applications can include an application for affecting a state change of a movable barrier operator based on a concentration of one or more gases.

### Detecting the Presence of an Object Within a Structure

With continued reference to FIG. 1, processor 102 is instructed to perform operations comprising detecting the presence of an object 106 within a structure. The object 106 may include any identifiable object that can be perceived, detected, or interacted with. As used in the current disclosure, the object 106 may refer to a vehicle 108, a person 110, or an animal. The vehicle 108 may include, without limitation, an automobile, a truck, a bicycle, a motorcycle, an ATV, and/or other means of transportation. The object 106 can include a single object or a plurality of objects. The plurality of objects can include the same type of objects (e.g., a plurality of vehicles 108) or a plurality of different types of objects (e.g., a vehicle 108 and a person 110, two vehicles 108 and one person 110, n vehicles 108 and m persons 110, etc.). Detecting the presence of the object 106 within the structure may include detecting the presence of the object 106 based on data provided by one or more image capture devices 112 and/or other types of sensors.

In some implementations, processor 102 may detect the presence of the object 106 by identifying a spatial relationship between the vehicle 108 and the structure using an ultra-wide band (UWB) system. UWB systems may employ a substantial portion of the radio frequency spectrum with very low power levels over a short range. UWB systems may spread their signal over a wide frequency range, typically spanning several gigahertz (GHz) or more. In an embodiment, UWB system may operate over a frequency range spanning from 3.1 GHz to 10.6 GHz. The UWB system may include a first wireless communication accessory and a second wireless communication accessory. As used in the current disclosure, a wireless communication accessory may be a transmitter (anchor), a receiver (tag), and/or a transceiver. The first wireless communication accessory may be mounted within the structure, while the second wireless communication accessory may be mounted to the vehicle.

Processor 102 may identify the spatial relationship between the first wireless communication accessory and the second wireless communication accessory using the time-of-flight (ToF) of the radio signals. ToF may be useful in identifying the distance between the wireless communication accessories. In an embodiment, the first wireless communication accessory and the second wireless communication accessory may communicate through short-duration, high-bandwidth pulses. For example, when the second wireless communication accessory emits a signal, the first wireless communication accessory receives it and measures the time it took for the signal to travel from the second wireless communication accessory to the first wireless communication accessory. This measurement of time may be useful because the speed of radio waves is a constant known value (the speed of light). By multiplying the time of flight by this speed, the distance between the first wireless communication accessory and the second wireless communication accessory can be accurately calculated. This distance measurement may be used to determine the spatial relationship between the first wireless communication accessory and the second wireless communication accessory.

To determine the presence of the vehicle 108, processor 102 can leverage the spatial relationship between the first wireless communication accessory and the second wireless communication accessory. The ToF measurement may be used to determine the spatial relationship between the first wireless communication accessory's position relative to the second wireless communication accessory. Given that the speed of radio waves is constant, the processor 102 can convert this ToF measurement into a precise distance calculation. This calculated distance provides a clear understanding of the vehicle's position relative to the structure. By comparing this distance with predefined thresholds or boundaries, the processor 102 can confirm whether the vehicle is within the structure or has reached a specific location.

In an embodiment, processor 102 may determine the presence of an object 106 using a Wi-Fi-based system. This may be done by analyzing the signal strength and characteristics of Wi-Fi communication between the vehicle and Wi-Fi access points in and around the structure. In this system, Wi-Fi access points or routers may be positioned in the vicinity of the garage and/or structure, while the vehicle is equipped with a Wi-Fi-enabled device. Examples of Wi-Fi-enabled devices may include but are not limited to user devices, dedicated Wi-Fi modules integrated into the vehicle's infotainment or telematics systems, onboard diagnostics (OBD) devices with Wi-Fi capabilities, in-car Wi-Fi routers and the like. When the vehicle's Wi-Fi device interacts with Wi-Fi access points, processor 102 monitors the received signal strength indicator (RSSI) and signal quality. By continuously measuring RSSI values and analyzing their variations as the vehicle moves, the processor 102 determines the vehicle's proximity to each access point. It also considers signal propagation patterns to adjust for interference or obstacles. These data points enable the processor 102 to accurately estimate the vehicle's location within the monitored area and track its movement based on changes in signal strength and connectivity patterns.

In an embodiment, processor 102 can determine the presence of an object 106 using a GPS-based system by analyzing the geographical coordinates provided by GPS receivers associated with the object 106 and the surrounding environment. In an embodiment, the GPS receiver associated with the object 106 may include a user device, a smartphone, vehicle infotainment system, and the like. The GPS system may pinpoint the precise location of the object 106 in real-time. When the object's 106 GPS receiver transmits its coordinates to the processor 102, the processor 102 may compare these coordinates with predefined geofences or target areas within the system's map database. By assessing whether the object's coordinates fall within specific boundaries or proximity zones, the processor 102 can confirm the object's presence within the structure.

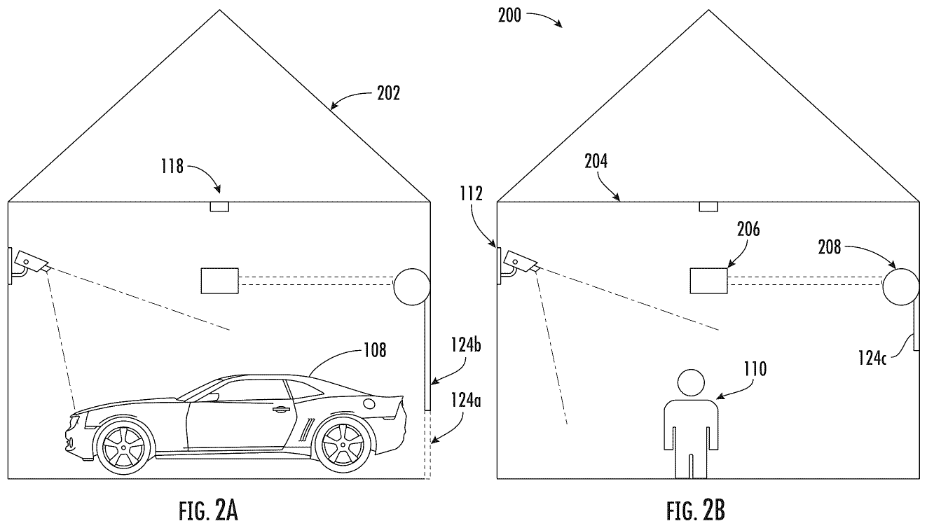

FIGS. 2A-B each depict a side view of an exemplary structure 202. FIGS. 2A-B depict two exemplary embodiments of the structure 202 where at least one object 106 is present within the structure 202. In particular, FIG. 2A depicts the object 106 in the form of a vehicle 108 and FIG. 2B depicts the object 106 in the form of a person 110. As depicted, the structure 202 may include, or be part of, a garage 204.

FIGS. 2A-B depict the image capture device 112 capturing image data 114 (FIG. 1) associated with the object 106 in the garage 204. The image capture device 112 may be positioned to generate image data 114 related to the interior of the structure 202. Alternatively, or in addition, the image capture device 112 may be positioned to generate image data 114 related to an exterior (or exit) of the structure 202. The image capture device 112 can include a plurality of image capture devices 112 strategically placed in one or more (e.g., a plurality of) locations within the structure 202, including but not limited to at walls, ceilings, floors, or shelving units. The placement of the image capture device(s) 112 should allow for comprehensive coverage and detailed imaging of designated portions of the interior of the structure 202. The image capture device(s) 112 may be equipped with several sensors and cameras to produce image data 114. The image data 114 may include images and videos that offer visual information related to the structure's interior. In addition to traditional image data 114, the image capture device 112 may capture thermal images, which can reveal temperature variations across surfaces. Furthermore, in certain embodiments the image capture device 112 may include one or more types of sensors such as lidar sensors, optical sensors, thermal sensors, infrared sensors, audio sensors, and the like.

The image data 114 may include visual information pertaining to a given structure. This data can be obtained through various imaging modalities, including but not limited to standard photographic and video imaging. The image data 114 may include a range of imaging outputs that collectively offer a comprehensive portrayal of the structure's interior environment. Specifically, the image data 114 may encompass visual content, such as photographs and video recordings, which document the visual characteristics of object(s) 106 within, or at, the interior of the structure 202. In addition to these conventional imaging forms, the image capture device 112 may also capture thermal images. Thermal imaging may be used to highlight areas of heat emission or absorption, which may be used to identify one or more characteristics of a vehicle 108 or presence of the object 106 within the structure 202.

Referring to FIG. 2A, the image capture device 112 may be configured to generate image data 114 associated with the vehicle 108. The image capture device 112 may create a comprehensive set of images that can be used to identify the vehicle 108. For example, the image data 114 may depict various attributes of the vehicle 108, such as its make, model, color, orientation, state, occupancy status, and the like. This image data 114 may allow the image processing model 116 to perform tasks such as vehicle identification.

With continued reference to FIG. 2B, the image capture device 112 may be configured to generate image data 114 associated with the person 110. The image capture device 112 may create a comprehensive set of images that can be used to identify the person 110. For instance, the image data 114 may include various attributes of the person 110, such as their arms, legs, feet, hands, head, facial features, posture, and movements.

The processor 102 may perform operations that include processing the image data 114 to detect the presence of the object(s) 106 within the structure. The presence of the object(s) 106 may be identified based on their presence within any distinct entity within an image or video frame that can be identified, analyzed, and categorized through computational methods. This may include a range of visual elements characterized by specific attributes such as shape, color, texture, and spatial positioning.

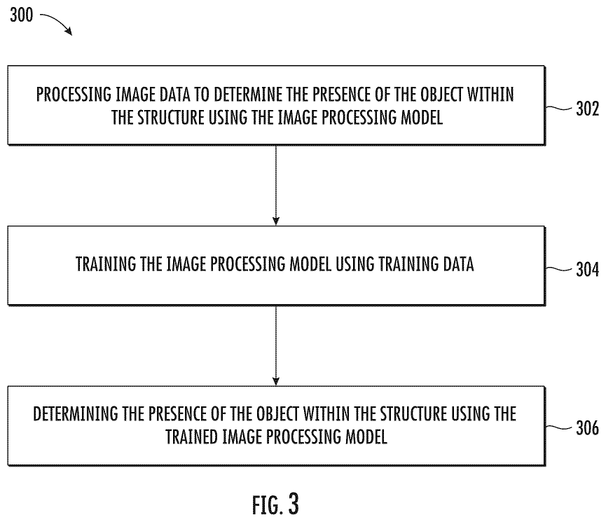

FIG. 3 depicts a flow diagram of an exemplary method 300 for determining presence of a vehicle within a structure using an image processing model in accordance with embodiments of the present disclosure.

At step 302, processing the image data may include processing the image data using an image processing model, such as the image processing model 116. The image processing model may refer to a computational framework designed to analyze, interpret, and transform image data through various algorithms and techniques. This image processing model may be used to extract meaningful information, such as the identification of the presence of one or more objects from visual inputs. The image processing model can encompass a range of functionalities depending on its intended application. The image processing model may be configured to enhance, analyze, and interpret image data to extract relevant information, detect features, and perform tasks such as classification, segmentation, and transformation.

To identify objects, the image processing model may segment the image data to isolate potential objects from the background and other irrelevant features. Segmentation is a process where the image processing model divides the visual information into distinct regions or segments. Segmentation may be used to isolate potential objects from the background and other irrelevant elements. Initially, segmentation techniques may be used to identify one or more areas of interest within the image by distinguishing between different parts of the scene based on attributes like color, texture, and intensity.

Once the image data has been segmented, the image processing model may proceed to extract relevant features from the segmented regions. Features may include any distinctive attributes or patterns within the image that are used for object recognition. The image processing model may be configured to extract features from the image data that are relevant to any part of the system. This may include the state of the movable barrier operator, characteristics associated with the vehicle, the detection of the presence of objects, and the like. Additional disclosure for these embodiments is provided herein below.

For features associated with vehicles, the image processing model may focus on attributes which are characteristic of vehicles such as geometric shapes (i.e., rectangles, circles, and ellipses, and the like.). For example, the rectangular outline of a vehicle's body and the circular shapes of its wheels are each feature that can be used to identify the vehicle from the remainder of the background. Additionally, the processor can analyze color schemes, looking for typical vehicle paint patterns and colors that can aid in distinguishing different vehicle types. The surface texture of the vehicle, such as smooth or reflective areas, is also examined to match with known vehicle types or models.

For features associated with people, the image processing model may extract one or more human-specific features from the plurality of image data. This may include features like the body shape and form, this includes silhouettes of the human body, head, torso, arms, hands, feet, digits, and legs. These silhouettes may be used to distinguish human figures from other objects. The image processing model may also track movement patterns, such as walking, running, crawling, falling, and the like, which helps in recognizing people, especially when they are in motion.

When identifying people within the vehicle, the image processing model may utilize a approach tailored to the unique constraints of the vehicle's environment. In such scenarios, the image processing model may focus on detecting partial or obscured human forms due to the confined and often cluttered space within the vehicle. The image processing model may analyze one or more specific indicators like the human silhouette visible through windows or gaps, the shape of heads and limbs as they might appear in various seating positions, and any movement within the confined space. The image processing model may also use pattern recognition to differentiate between human figures and vehicle components or other interior elements. Even when people are partially obstructed or only partially visible, the processor can employ thermal imaging data, if available, to detect heat signatures corresponding to human bodies.

At step 304, the image processing model may be trained using training data. Training data may include a plurality of data entries containing a plurality of inputs that are correlated to a plurality of outputs for training a processor by a machine-learning process. In an embodiment, training data may include a plurality of images correlated to examples of objects. Examples of objects may include examples of vehicles, examples of people, and/or examples of people located within vehicles. In some instances, the training data may include examples of vehicles with varying characteristics and states. Training data for the image processing model may include a large set of labeled images that represent various categories or scenarios the model needs to recognize. These categories may include things like vehicles with the doors open/closed, engine on/off, various orientations, various occupancy status, images with the object present/absent, and the like. This training data may include not only raw images but also annotations or labels that provide context. These annotations may highlight features like the state of the vehicle or the presence/absence of the object. To ensure the model generalizes well, the training set often includes images from different environments, lighting conditions, and angles, along with variations in resolution and quality.

In an embodiment, training data may include a large dataset of historical image data. By training on historical image data, including previously identified objects and/or characteristics of the vehicle, the machine learning model may identify patterns and trends that are used to successfully identify objects within the structure. The image processing model may continuously improve its predictions and recommendations by analyzing these patterns and adapting its algorithms based on new data. This enables the image processing model to provide improved accuracy of the identification of objects and various vehicle characteristics.

Training the image processing model may involve refining its parameters, such as weights and biases, by processing previous identifications of objects and various vehicle characteristics. The image processing model may be used to accurately identify objects and various vehicle characteristics. During training, an error function may be used to evaluate the difference between the image processing model's predicted object identification and the actual identification of objects data from past attempts. This discrepancy may be used to guide the iterative adjustment of the image processing model's parameters, such as weights and biases. The error function may be used to minimize this error by continuously refining the image processing model's parameters through processes like gradient descent. As these adjustments proceed, the image processing model may become increasingly accurate in predicting identification of objects and various vehicle characteristics based on historical image data. The adjustments may continue to proceed until performance stabilizes, indicating that the predictions are sufficiently accurate. By using techniques such as gradient descent or back-propagation, the image processing model learns to minimize the discrepancy between its predicted outputs and the real identifications of objects, ultimately improving its ability to identify objects. This training process may be applied to any algorithm, machine learning model, image processing model, and the like described herein.

At step 306, processor may be configured to determine the presence of the object, or objects, within the structure using the trained image processing model. Step 306 may include using the image processing model to classify features within the image data into one or more categories. Classifying the features may include using the image processing model to assign labels or categories to the identified object(s) or feature(s) within an image. The classification process may be used to transform raw image data into structured data that can be easily understood and utilized for various applications.

The classification component of the image processing model may rely on predefined criteria or machine learning models, as described throughout the entirety of this disclosure. Predefined criteria might involve rule-based systems where specific characteristics or attributes are used to classify objects. For instance, a simple rule might classify any object with a rectangular shape and wheels as a vehicle, or any object with a silhouette similar to a human as a person.

More advanced classification may be achieved through machine learning models, particularly those based on deep learning techniques. Convolutional Neural Networks (CNNs) may be employed for this purpose. These image processing models may be trained on large datasets containing numerous examples of different object categories. During the training process, the CNN may learn to recognize and differentiate between various features and patterns associated with each category. For example, the image processing model might be trained on thousands of images labeled as vehicles, people, characteristics associated with a vehicle, or buildings, learning to identify distinguishing characteristics such as the shape of a car, the form of a human body, or the structure of a building. Training the machine learning model may be done in any fashion described within the current disclosure.

Once trained, the CNN or other machine learning model can analyze the image data and classify objects based on the learned patterns. The image processing model processes the features or segments identified in the image, applying the image processing model's knowledge to assign appropriate labels or categories. For example, if the image processing model detects a segment with a specific set of features resembling those of a vehicle, the image processing model can classify that segment as a vehicle. Similarly, if another segment exhibits characteristics typical of human figure(s), it may be classified as a person.

### Identifying the Characteristics of the Vehicle

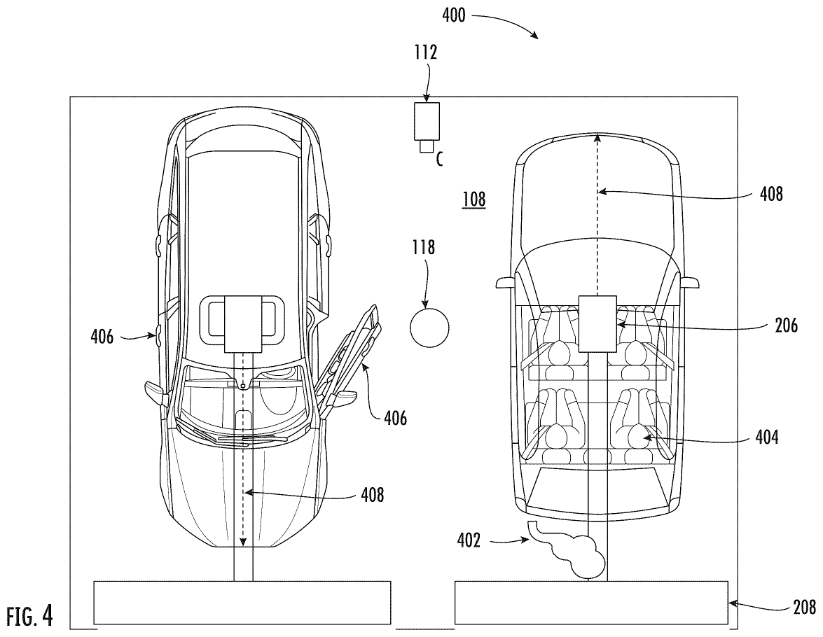

FIG. 4 depicts an exemplary embodiment of an aerial view of the structure including a vehicle 108 (FIG. 1). In one or more embodiments, processor 102 (FIG. 1) may be instructed to identify one or more characteristics of the vehicle 108. The one or more characteristics of the vehicle may describe various aspects associated with the vehicle 108. These aspects include, but are not limited to, the vehicle's state 402, an occupancy status 404, an operation history of the vehicle 108 (such as the operation history of one or more of the doors of the vehicle 108), an orientation 408 of the vehicle 108, vehicle dimensions and measurements, and the like. These characteristics of the vehicle 108 may be used to adjust, modify, and/or tailor the control instructions 128 for the movable barrier operator 126.

Processor 102 may be instructed to perform operations that include determining the state 402 of the vehicle 108. The state 402 of the vehicle 108 may refer to a determination of whether the vehicle's engine is currently on or off. The state 402 of the vehicle may additionally, or alternatively, refer to a length of time that the vehicle 108 has been in a current state 402. The state 402 of the vehicle may be used to determine if the vehicle 108 is the source of the elevated concentration of gas. To determine the state 402, processor 102 may assess whether the vehicle's engine is currently running. To determine if the engine is currently running, the processor 102 may evaluate various forms of data including, for example, image data, thermal data, data associated with the vehicle's ignition system, data associated with the vehicle's engine control unit (ECU), data associated with engine noise, and the like.

When determining the state 402 of the vehicle, processor 102 may also monitor the duration for which the vehicle has remained in its current state. This temporal aspect of state 402 may be useful for various diagnostic and operational purposes. For instance, if the vehicle has been on for an extended period, it might indicate that the concentration of the gas may be elevated.

In some cases, processor 102 uses the information about the vehicle's state 402 to assess whether the vehicle is contributing to an elevated concentration of gases within the structure. By analyzing the duration of the engine's operation and correlating it with sensor data, the processor can determine if the vehicle is a potential source of an elevated concentration of a gas within the structure 202, as discussed in greater detail herein below.

In an embodiment, processor 102 may utilize image data 114 (FIG. 1) to determine the state 402 of the vehicle. Processor 102 may process the image data 114 to detect various indicators associated with the state 402 of the vehicle, such as movement of engine components, the presence of engine-related visual cues (such as exhaust smoke or vibration of one or more components of the vehicle like the engine hood), or the operational state of specific vehicle parts. In some embodiments, the processor 102 can identify whether the engine is running by recognizing the rotation of engine belts or the operation of moving parts. Additionally, the processor 102 can identify whether the engine is running by identifying the presence of exhaust smoke or heat signatures. Processor 102 may process this image data 114 in the manner discussed above. This includes but is not limited to the use of the image processing model 116 to interpret visual cues to accurately determine the state 402 of the vehicle.

In other embodiments, processor 102 may determine the state 402 of the engine by analyzing thermal data obtained from the image capture device 112. The image capture device 112 may include various infrared sensors or thermographic cameras. These image capture devices 112 may be used to detect heat emissions and temperature variations associated with engine operation. When the engine is running, the engine generates a thermal signature due to the combustion process and friction between engine components. The thermal signature may additionally include the thermal signature from the exhaust system of the vehicle. Processor 102 may evaluate this thermal data to identify patterns indicative of active engine operation, such as elevated temperatures and localized heat sources consistent with engine activity. By comparing these thermal signatures against predefined thresholds and patterns associated with a running engine, the processor can accurately determine whether the engine is currently operational or off, thereby ascertaining the vehicle's state 402.

In some cases, processor 102 may determine the state 402 of the engine by analyzing audio data related to engine noises captured using an audio capture device associated with the image capture device 112 or via a separate audio capture device. The image capture device 112 may be used to detect and record acoustic data, such as sound frequencies and patterns generated by the engine during operation. When the engine is running, it produces a characteristic range of sounds, including the rhythmic noise of combustion, the whirring of moving parts, and the hum of the engine's various components. Processor 102 may process this acoustic data to identify these specific noise patterns, distinguishing them from background or idle sounds. By analyzing the intensity, frequency, and regularity of these noises, the processor can accurately determine the vehicle's state 402.

In additional embodiments, processor 102 may determine the state 402 of the engine by receiving and analyzing data transmitted from one or more of the vehicle's integrated system(s) and/or a connected app. This may include data from the vehicle's ignition system, which provides information on whether the ignition is engaged and actively firing. Additionally, processor 102 may evaluate data from the engine control unit (ECU), which monitors and manages engine operations by reporting metrics such as engine RPM (revolutions per minute), fuel injection status, and overall engine performance. By integrating this data, processor 102 can accurately assess whether the engine is currently running or off.

Processor 102 may be instructed to perform operations that include determining the occupancy status 404 of a vehicle 108. The occupancy status 404 of a vehicle pertains to the determination of whether individuals are currently present within the vehicle. The occupancy status 404 may be defined by an assessment of the real-time occupancy of the vehicle 108. Processor 102 may determine the occupancy status 404 for vehicle 108 by processing the image data 114 to ascertain the real-time occupancy of the vehicle 108. The processor 102 may instruct the image processing model 116 to deploy object recognition algorithms and/or machine learning models to detect the presence of individuals by analyzing visual cues such as body shapes, movement, and typical human behavior within the vehicle's interior. The image processing model 116 may compare this visual data against predefined patterns to determine whether people are currently present.

In an embodiment, the image data 114 may include thermal images that include heat signatures emitted by living organisms. The image processing model 116 may be used to highlight areas of elevated temperatures that correspond to human presence within the image data 114. The processor 102 may analyze these thermal patterns to identify warm regions that signify the presence of individuals.

In an additional embodiment, the occupancy status 404 of the vehicle may be determined based on the response to a query or notification sent to a user device. In this embodiment, system 100 may send a query or notification to a registered user device. This query or notification could be a direct request asking whether the user is inside the vehicle 108, structure 202, or garage 204. Alternatively, the query or notification may include an automated check-in notification. The user's response, whether it is a confirmation of their presence or an acknowledgment that they are outside the vehicle, may provide the necessary data to determine the current occupancy status 404.

In an additional embodiment, the occupancy status 404 may be determined by monitoring user activity on a user device that is connected to or associated with the vehicle. System 100 may be able to track interactions on a user device to identify the occupancy status 404 of the vehicle. These interactions may include interactions with an app or connected services, such as logging in to the vehicle's interface, using vehicle-related features (e.g., climate control, navigation), or accessing vehicle diagnostics. If activity such as adjusting settings or checking status is detected from the user device, it can be inferred that the user is likely present inside the vehicle. The system analyzes patterns of usage and interaction with the vehicle's connected services to infer the occupancy status 404, thus providing an indirect but effective method of determining whether individuals are inside the vehicle based on their engagement with the vehicle's digital ecosystem.

Determining the occupancy status 404 of a vehicle 108 may include determining an operation history 406 of one or more of the doors of the vehicle 108. The operation history 406 of the vehicle doors refers to a record of the times and events when the vehicle's doors have been opened or closed. This operation history 406 may be used to assess the occupancy status 404 of the vehicle, particularly in determining if a person is still inside or has exited the vehicle. The operational history 406 may encompass a detailed log of door activity, including timestamps and the sequence of door operations. This log may be generated by processing image data 114 or by receiving information associated with electronic control units (ECUs). Each time a door is opened or closed, system 100 may capture the event and records the relevant data, such as the specific door involved, the exact time of the event, and the duration of the door being in an open or closed state.

For example, if the operational history 406 indicates that the vehicle's doors have been opened recently but there are no subsequent records of the doors being closed, this situation suggests that a person may have exited the vehicle. The absence of a closing event following an opening event may create a strong inference that the vehicle is currently unoccupied, as it implies that the doors were not closed after the last use. Conversely, if the operational history shows that the doors have been closed and remain in the closed state for an extended period, this can be interpreted to imply that the vehicle is currently occupied. The extended duration of the doors being closed suggests that the vehicle has not been recently accessed, which may indicate that individuals are inside and have not opened the doors. In this case, the system 100 may determine that if the doors were recently closed and have remained closed, there is a higher likelihood that the vehicle's occupants are still inside, especially if other indicators such as internal activity or temperature changes are consistent with occupancy.

In an embodiment, processor 102 may evaluate image data 114 to determine the operational history 406 of a vehicle's doors. The image capture device 112 may be used continuously to monitor door movements. When the doors are opened or closed, the image capture device 112 may capture visual evidence of these actions. The image processing model 116 may then be used to analyze the footage to detect changes in door positions, such as the transition from closed to open or vice versa. The image processing model 116 may employ various image processing techniques, such as object detection and motion analysis, to enable the system to recognize and analyze patterns related to door usage. For example, the system can identify the frequency and duration of door openings and closings, distinguishing between normal use and unusual patterns that might indicate issues or specific occupancy scenarios.

The image data 114 may be tagged, e.g., with timestamps that correspond to when specific door operations occur. By synchronizing the image data 114 with precise time data, processor 102 may create a detailed timeline of door activities. This timeline includes when each door was opened, closed, or remained stationary, which may be used to construct the operational history 406.

Processor 102 may be instructed to perform operations that include determining the orientation 408 of the vehicle 108. The orientation 408 of the vehicle, as used within the current disclosure, specifically refers to the vehicle's directional alignment, focusing on whether the vehicle is facing forward or backward. A backwards orientation may refer to the situation where the vehicle's front end is directed towards the movable barrier 208, while the rear end is positioned away from the movable barrier 208. Conversely, when the vehicle is described as facing forward, it means that the front end of the vehicle 108 is directed opposite of the movable barrier 208, and the rear end is near the movable barrier 208.

In some embodiments, image data 114 may be used to determine the orientation 408 of the vehicle. The image data 114 may be processed using the image processing model 116 to identify key vehicle features such as the front grille, headlights, and rear lights. By comparing these features to the surrounding environment, such as movable barriers or parking lines, the system 100 can discern whether the vehicle is facing forward or backward. This visual analysis may be combined with additional data from navigation or proximity sensors to ensure accurate assessment of the vehicle's directional alignment.

Processor 102 may be instructed to perform operations that include determining the dimensions of a vehicle 108. The processor 102 may be configured to receive a plurality of information associated with the vehicle based on one or more unique identifiers associated with the vehicle. This may include information such as a vehicle identification number (VIN). The processor 102 can utilize a vehicle's unique identifier to identify information about the vehicle from a database. When the unique identifier is provided, the processor may query the database, which contains comprehensive records on various vehicle attributes. By matching the unique identifier or VIN with the database entry, the processor may retrieve specific details about the vehicle such as the vehicle's make and/or model, height, length, weight, exhaust height, a vehicle rider profile identifying the driver of the vehicle, or the like. Height of the vehicle may refer to the vertical measurement from the ground to the highest point of the vehicle. Alternatively, height may refer to the height of the vehicles exhaust. Length may refer to the overall distance from the front bumper to the rear bumper. The dimensions of the vehicles may be modified according to the presence/absence of tools and equipment that are attached to the vehicle. This may include equipment like luggage racks, bike racks, trailer hitches, trailers, spare tires, lift kits, shocks, and the like.

### Identifying a Concentration of Gas(es) Within the Structure

With continued reference to FIG. 1, the processor 102 is instructed to perform operations comprising receiving sensor data 120 that identifies a concentration of a gas, or gases, within the structure 202. Sensor data 120 describing the concentration of gas(es) may refer to a quantitative measurement of the presence and amount of a specific gas within a given environment, as recorded by a sensor 118. Sensor data 120 may quantify the concentration of a gas in units such as parts per million (ppm), parts per billion (ppb), or milligrams per cubic meter (mg/m³). The sensor 118, designed to detect and measure gas concentrations, converts the detected gas levels into a readable output that reflects the gas's presence in the air.

Sensor data 120 may include information associated with a wide range of gases, including but not limited to carbon monoxide (CO) and natural gas (primarily methane, CH₄). Carbon monoxide is a particularly dangerous gas due to its colorless and odorless nature, which makes it undetectable by human senses. Carbon monoxide is a byproduct of incomplete combustion of carbon-containing fuels, such as gasoline, diesel, and natural gas. Because of its high toxicity, carbon monoxide can interfere with the body's ability to transport oxygen, leading to serious health issues.

In residential and industrial settings, sensor 118 may be used to detect and monitor the concentrations of one or more gases. Sensors 118 may utilize various technologies tailored to different types of gases and their specific detection requirements. In an embodiment, the sensor 118 may include an electrochemical sensor. Electrochemical sensors operate by passing a gas through a chemical cell where the gas reacts with a chemical reagent. This reaction generates an electrical current proportional to the gas concentration, allowing for accurate measurement. Electrochemical sensors are particularly effective for detecting gases like carbon monoxide (CO), providing high sensitivity and selectivity for these hazardous substances.

In another embodiment, a sensor 118 may include a metal oxide semiconductor (MOS) sensor. MOS sensors detect gas concentrations by measuring changes in the electrical resistance of a semiconductor material. When a target gas interacts with the sensor's 118 surface, it alters the material's resistance, which is then translated into a concentration reading. MOS sensors may be used for detecting gases such as carbon dioxide (CO₂), methane (CH₄), and various volatile organic compounds (VOCs).

In an additional embodiment, a sensor 118 may include one or more infrared (IR) sensors. IR sensors may use infrared light to measure the amount of gas present; as the gas absorbs specific wavelengths of IR light, the decrease in light intensity is correlated with the gas concentration. IR sensors are ideal for detecting gases like carbon dioxide (CO₂) and methane (CH₄) due to their high specificity and non-invasive measurement method.

Processor 102 is configured to perform operations that include comparing the identified concentration of the gas with the concentration threshold 122. The concentration threshold 122 refers to a predefined level or limit of gas concentration that triggers specific actions or responses within a monitoring system. This threshold may be established based on safety standards, regulatory requirements, or operational guidelines to ensure that gas concentrations remain within safe or acceptable limits. In an embodiment, the concentration threshold 122 is used to set alarm levels or activate safety mechanisms when gas concentrations reach or exceed a certain point. For example, the concentration threshold 122 might be set to trigger an alarm if the concentration of a hazardous gas, such as carbon monoxide or methane, surpasses a critical level. This helps in preventing potential health risks, environmental damage, or safety incidents by prompting timely intervention.

In an embodiment, concentration threshold 122 may be categorized into one or more levels. These level(s) may include, for example, a warning threshold, an alarm threshold, and an action threshold. The warning threshold may be a lower concentration level that indicates the presence of a gas but is not immediately dangerous. It serves as an early warning to address potential issues before reaching more critical levels. For carbon monoxide, a warning threshold may be around 30 parts per million (ppm). At this level, the presence of CO is noted, and it signals the need for closer monitoring and potential ventilation improvements to prevent concentrations from rising further.

The alarm threshold may represent a higher concentration level where immediate action is required to prevent health risks or safety hazards. Once a gas concentration crosses the alarm threshold, safety measures such as ventilation systems, alarms, and the like may be triggered. For carbon monoxide, the alarm threshold may be set at around 100 ppm. At this level, safety alarms are activated, and corrective actions such as increasing ventilation or investigating the source of the CO leak are required to mitigate the risk of health effects. This may include changing the state of the movable barrier operator 126 to an open position 124c.

The action threshold may represent a concentration level that necessitates corrective actions or operational changes, such as evacuating an area, shutting down equipment, or conducting further investigations. For carbon monoxide, the action threshold may be set at 200 ppm or higher. At this concentration, immediate actions such as evacuating the area, shutting down equipment, and initiating emergency procedures are necessary to prevent severe health effects, including potentially life-threatening conditions. This may include changing the state of the movable barrier operator 126 to an open position 124c. Additionally, crossing the action threshold may include sending a notification to a user device or to emergency medical services. Yet other levels (i.e., thresholds) may be implemented concurrently or alternatively with the above-described examples. Yet further, the user may be able to adjust the threshold levels, e.g., using a smart device in communication with the sensor or another component of the system.

Comparing sensor data 120 to the concentration threshold 122 involves evaluating real-time measurements from a gas sensor against predefined safety or operational limits to determine if any action is required. In some embodiments, sensor data 120 is continuously compared to the concentration threshold 122 to monitor gas levels in real-time. If the measured concentration reaches or exceeds the warning threshold, it may indicate that the gas concentration is elevated but not yet at a critical level.

In an embodiment, processor 102 may send a notification to a user device based on the concentration of gas exceeding a threshold. If the gas concentration surpasses the warning threshold but remains below the alarm threshold, processor 102 may generate a non-urgent notification to alert users of elevated gas levels. This notification may include recommendations for increased monitoring or preventive actions. For gas concentrations that exceed the alarm threshold, the processor 102 may send a more urgent notification. The more urgent notification may be accompanied by audible alarms or visual indicators. This notification may instruct users to take immediate action, such as evacuating the area and ventilating the space by changing the state 124a-c of the movable barrier operator 126. In cases where the gas concentration reaches or exceeds the action threshold, the processor 102 may issue a critical notification with urgent instructions, including emergency contact information and steps for immediate response. These notifications may include suggestions to modify the state of the movable barrier operator or identifying and terminating the source of the gas (i.e., turning off the vehicle's engine).

Notifications can be delivered through various channels (simultaneously or separately), such as mobile apps with push notifications, emails, SMS or text messages, and physical alarms to ensure that users are promptly informed. In some embodiments, system 100 may require the user to acknowledge receipt of the notification and may log the details for follow-up actions.

### Determining the Current State of the Movable Barrier Operator

With continued reference to FIG. 1, the processor 102 is configured to determine a current state 124a-c of a movable barrier operator 126. The current state 124 of the movable barrier operator 126 is defined based on the position of the actuatable component of the movable barrier operator 126 within its operational range. This position may directly correlate to the position of the movable barrier 206. The current state 124a-c of the movable barrier operator 126 may be categorized as either fully closed 124a, partially open 124b, and/or fully open 124c. Specifically, when the movable barrier operator 126 is in the fully open position 124c, the movable barrier 206 is completely retracted, allowing unobstructed passage through the opening it controls. Conversely, when in the movable barrier operator 126 is in the fully closed position 124a, the movable barrier 206 is extended to block the passage, ensuring no entry or exit is possible. The partially opened/closed state 124b describes a position where the barrier is neither fully retracted nor fully extended, thus allowing for ventilation while maintaining partial obstruction.

In an embodiment, processor 102 may be configured to receive information associated with the movable barrier operator 126. This information may be received from a local or a remote computing device associated with the movable barrier operator 126. In some cases, information associated with the movable barrier operator 126 may include information about the current state 124a-c of the movable barrier operator 126. The information associated with the movable barrier operator 126 may encompass data reflecting the current state 124a-c of the barrier. This data includes real-time positional feedback indicating whether the movable barrier operator 126 is in a fully closed state 124a, a partially open/closed state 124b, or a fully open state 124c. For example, when the movable barrier operator 126 is fully closed 124a, the data will show that it is fully extended to block the passage, whereas if it is fully open 124c, the movable barrier operator 126 is completely retracted, allowing clear passage. The partially open/closed state 124b indicates a transitional position where the barrier is neither fully retracted nor fully extended, allowing for ventilation while still partially obstructing the opening.

In an embodiment, image data 114 may be used to identify the current state 124a-c of the movable barrier operator 126. The image capture device 112 may be positioned to capture real-time images or video feeds, which are then analyzed to determine the current state 124a-c of the movable barrier operator 126. By employing the image processing model 116, system 100 can detect specific visual cues, such as the extent of the movable barrier operator's 126 opening or closing and translate these visual indicators into actionable data. For example, if the images show that the barrier is fully retracted, the image processing model 116 may determine that the movable barrier operator 126 is in the fully open state 124c. Image data 114 can also identify partial openings or closings, corresponding to the partially open/closed state 124b.

The image processing model 116 may use various image processing techniques to identify the current state 124a-c of the movable barrier operator 126. By interpreting features such as the barrier's position, angle, and extent of opening from the images, the image processing model 116 can classify the state into one of the predefined categories: fully closed 124a, partially open/closed 124b, or fully open 124c. The image processing model's 116 ability to distinguish between these states is based on patterns and visual cues in the images, allowing for accurate and real-time monitoring of the barrier's operational status. System 100 maty use any image processing techniques disclosed herein to determine the current state 124a-c of the movable barrier operator 126.

### Determining and Communicating the Control Instruction

With continued reference to FIG. 1, processor 102 may be instructed to perform operations that comprise determining a control instruction 128 to control the state 124 of the movable barrier operator 126 in response to the comparison of the identified concentration of the gas with the concentration threshold and the current state 124 of the movable barrier operator. The control instruction 128 may be a command signal that manages and/or regulates operation of a system or device, such as the movable barrier operator 126. The command signal may specify a desired action or transformation, such as engaging or disengaging a movable barrier operator 126 to affect a state of an associated movable barrier 208. The command signal may also include instructions that affect the control state of an appliance (e.g., between on and off settings), adjusting settings, initiating a sequence of operations, and the like. When the control instruction 128 is received at the movable barrier operator 126, processor(s) of the movable barrier operator 126 may direct a motor or actuator associated with the movable barrier operator 126 to perform the specified action, such as raising or lowering the movable barrier 208. Safety protocols may be embedded in the control signal that halts or pauses the movable barrier operator 126 if a blockage of the movable barrier 208 is detected, thereby preventing damage or injury. The control instruction 128 may be issued through various interfaces, including remote controls, mobile apps, or automated systems, and is executed by the movable barrier operator.

The control instruction 128 may act as an operational command, guiding the movable barrier operator 126 on whether to open, close, or halt the movement of a movable barrier 208. When issued, the control instruction 128 may direct the movable barrier 208 to respond to user inputs or automated systems with the desired action. For instance, if the control instruction 128 is to open the movable barrier 208, the movable barrier operator 126 interprets this instruction to begin lifting or sliding the movable barrier 208, depending on its mechanism. Conversely, a control instruction 128 that includes a close instruction may trigger the movable barrier operator 126 to move the movable barrier 208 towards the closed position. In addition to basic open and close commands, control instructions 128 may specify detailed movements, such as partial openings or closings. For example, a control instruction 128 might direct the movable barrier operator 126 to open the barrier halfway, allowing for partial access while maintaining security or privacy. Similarly, the control instructions 128 might require the movable barrier operator 126 to close the barrier only partially, accommodating specific needs or ensuring safe operation. The movable barrier operator 126 may adjust the movable barrier's movement based on these control instructions 128, the adjustments may include variations in speed and direction. If the instruction calls for a slow, gradual opening or a quick, abrupt stop, the movable barrier operator 126 may adapt accordingly, ensuring the barrier performs precisely as intended.

To generate a control instruction 128, the processor 102 evaluates the comparison of the identified concentration of the gas with the concentration threshold and the current state 124 of the movable barrier operator. In an embodiment, processor 102 may generate the control instruction 128 to open the movable barrier 208 using the movable barrier operator 126 if both the concentration of the gas is above the concentration threshold and the current state of the movable barrier is closed. The generated control instruction 128 may involve partially or wholly opening the movable barrier 208 using the movable barrier operator 126. This ensures that the barrier is opened to ventilate the area when harmful gas levels are detected, and the vehicle is active, potentially indicating that the vehicle is in use or has recently been started.

In another embodiment, the processor 102 may issue the control instruction 128 to open the movable barrier 208 based on the vehicle's state 402. Specifically, when the vehicle's engine is running, the system may anticipate that gas concentration will increase over time. To address this, the processor 102 may preemptively generate a control instruction 128 to open the movable barrier 208 using the movable barrier operator 126. Furthermore, the processor 102 will continue to monitor gas levels while the engine remains on, allowing it to issue additional control instructions 128 to keep the barrier open as needed, ensuring effective ventilation and safety.

In another embodiment, the processor 102 may generate a control instruction 128 to open the movable barrier 208 based on the occupancy status 404 of the vehicle 108. If the processor 102 detects that the vehicle 108 or the surrounding structure is occupied by a person or animal, it may issue the control instruction 128 to open the movable barrier 208. Additionally, the processor 102 may adjust the concentration threshold 122 in response to the occupancy status 404. Specifically, when the vehicle is occupied, the concentration threshold 122 required to trigger the movable barrier opening may be lowered, ensuring a quicker response to potentially hazardous conditions.

In scenarios where the control instruction 128 is designed to adjust the movable barrier operator 126 to an open position, the processor 102 may modify this instruction based on the vehicle's orientation 408. Specifically, if the rear of the vehicle is directed toward the movable barrier 206, the processor 102 might alter the control instruction 128 to partially open the barrier rather than fully opening it. This adjustment could be tailored according to various vehicle features such as exhaust height, overall vehicle height, and other relevant characteristics. On the other hand, if the vehicle's orientation 408 has the front facing the movable barrier 208, the control instruction 128 may remain unchanged, and the barrier may open fully as initially intended.

In addition to vehicle orientation 408, the control instruction 128 may be adjusted based on the vehicle's dimensions. These dimensions may include the vehicle's height or the exhaust height of the vehicle. Specifically, the processor 102 may modify the control instruction 128 so that the height of the movable barrier 206 aligns more closely with the exhaust system. This adjustment may be useful to ensure that carbon monoxide and other exhaust gases can escape freely from the vehicle without being trapped or redirected by the barrier. The exhaust height may be generated based querying a database, as discussed in greater detail herein above. Additionally, the exhaust height may be generated based on analysis of the image data, as discussed in greater detail herein above.

With continued reference to FIG. 1, processor 102 may be instructed to perform operations that comprise causing communication of the control instruction 128 to the movable barrier operator 126 to control the state 124 of the movable barrier operator. Controlling the state 124 of a movable barrier operator may involve instructing the movable barrier operator to actuate a movable barrier, such as a garage door or gate, into a desired position. Causing communication of the control instruction 128 may include transmitting a command to the movable barrier operator to adjust the position of the movable barrier, such as opening, closing, pausing, and the like of the movable barrier.

Causing communication of the control instruction 128 may be designed to align the movable barrier operator's movements with the comparison of the identified concentration of the gas with the concentration threshold and the current state 124 of the movable barrier operator. Upon receiving the control instruction 128, the movable barrier operator 126 may process the command and adjust the movable barrier 208 accordingly. This may involve activating motors or mechanisms associated with the movable barrier operator 126 to physically move the barrier to the desired position. For example, if the control instruction 128 is to open the movable barrier, the movable barrier operator 126 may initiate the appropriate mechanism to lift or slide the movable barrier 208. Conversely, if the instruction is to close or partially close the barrier, the movable barrier operator 126 may be instructed to adjust the movable barrier's movement to securely seal off the entry point.

In addition to being controlled by the system 100 described above, the state 124 of the movable barrier operator 126 may be further affected by command signals received from one or more controllers, such as from one or more wireless communication devices (e.g., smartphones or tablets running movable barrier operator control applications), remote controls, wall switches, or the like. Processor 102 may process the command signals received from the one or more controllers and change the state 124 of the movable barrier by engaging/disengaging the motor or actuator of the movable barrier operator to perform the desired action.

In an embodiment, when a change occurs in the state 124 of the movable barrier operator 126, a notification may be generated to keep users informed of the update. This notification may be then transmitted to the user device, ensuring timely awareness of the barrier's operational status., Additionally, the notification may include information about any of the operations that are performed by system 100, including but not limited to information about the gas concentration within the structure 202.

If the notification system detects elevated gas concentrations within the structure 202 and determines that people 110 are present, it may automatically escalate the alert to emergency services. This escalation may involve sending a high-priority notification to the appropriate emergency response teams, detailing both the hazardous gas levels and the presence of individuals within the affected area. The notification may include real-time data on the gas concentration and the exact location of the people 110, enabling emergency services to quickly assess the situation and coordinate an effective response.

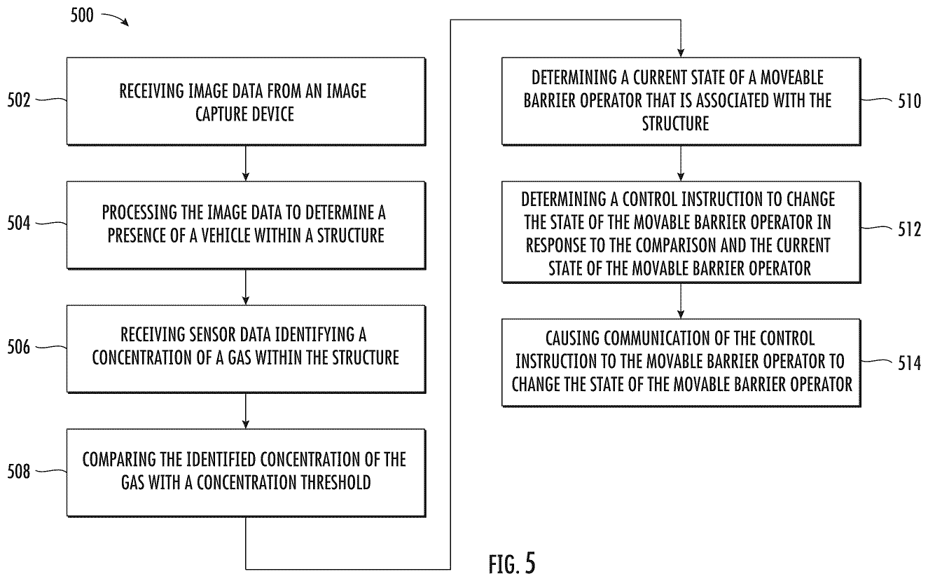

Referring now to FIG. 5, a flow diagram of an exemplary method for affecting a state change of a movable barrier operator based on a concentration of one or more gases in accordance with embodiments of the present disclosure.

At step 502, the method includes receiving, by a processor communicatively connected to a movable barrier operator and a sensor, image data from an image capture device.

At step 504, the method includes processing, by the processor, the image data to detect a presence of a vehicle within a structure. In an embodiment, detecting the presence of the vehicle may include determining the state of the vehicle. The control instruction may be determined based on the state of the vehicle. In some cases, receiving the image data may include receiving thermal image data from the image capture device. The thermal image data may be processed to determine the state of the vehicle. In another embodiment, detecting the presence of the vehicle further comprises identifying an occupancy status of a vehicle based on the image data. The control instruction may be determined based on the occupancy status of the vehicle. In some cases, processing the image data includes training an image processing model using training data. This may include processing the image data to detect the presence of the vehicle using the trained image processing model.

At step 506, the method includes receiving, by the processor, sensor data identifying a concentration of a gas within the structure.

At step 508, the method includes comparing, by the processor, the identified concentration of the gas with a concentration threshold.

At step 510, the method includes determining, by the processor, a current state of a movable barrier operator that is associated with the structure.

At step 512, the method includes determining, by the processor, a control instruction to change the state of the movable barrier operator in response to the comparison and the current state of the movable barrier operator.

At step 514, the method includes causing, by the processor, communication of the control instruction to the movable barrier operator to change the state of the movable barrier operator.

While the embodiments described herein may pertain to garages and associated environments, the disclosure is not limited thereto. For instance, the environment may include an interior of a residential building, and the sensor may be disposed in a room or hallway of the residential building. The movable barrier can include, for example, a window or a door, and the movable barrier operator can include a motorized controller for the window or door to reposition the window or door. Alternatively, or in addition, the movable barrier can include a vent and the movable barrier operator can include a motorized fan that, when activated, causes the vent to open, allowing venting of the environment. In yet another embodiment, the environment can include a commercial building, an industrial building, or other contained structures in which detecting the presence of gas(es) is desirable.

In some embodiments, the method additionally includes generating, by the processor, a notification based on the changed state of the movable barrier operator and the comparing. The notification may be transmitted to a user device.

Further aspects of the invention are provided by one or more of the following embodiments:
Embodiment 1. A computing system for affecting a state change of a movable barrier operator based on a concentration of one or more gases, the system comprising: a movable barrier operator associated with a structure; a processor communicatively connected to the movable barrier operator and a sensor; and a non-transitory computer-readable media that stores instructions that, when executed by the processor, causes the computing system to perform operations, the operations comprising: detecting a presence of an object within the structure; receiving, at the processor, sensor data identifying a concentration of a gas within the structure; comparing, by the processor, the identified concentration of the gas with a concentration threshold; determining a current state of the movable barrier operator; determining a control instruction to change the state of the movable barrier operator in response to the comparing and the current state of the movable barrier operator; and causing communication of the control instruction to the movable barrier operator to change the state of the movable barrier operator.
Embodiment 2. The system of embodiment 1, wherein detecting the presence of the object within the structure comprises detecting the presence of a vehicle within the structure, and wherein detecting the presence of the vehicle comprises: receiving image data from an image capture device; and processing the image data to detect the presence of the vehicle.
Embodiment 3. The system of embodiment 2, wherein detecting the presence of the vehicle further comprises detecting a state of the vehicle based on the image data; and determining the control instruction comprises determining the control instruction based on the state of the vehicle.
Embodiment 4. The system of embodiment 2, wherein detecting the presence of the vehicle further comprises identifying an occupancy status of the vehicle based on the image data; and determining the control instruction comprises determining the control instruction based on the occupancy status of the vehicle.
Embodiment 5. The system of embodiment 2, wherein processing the image data further comprises: training an image processing model using training data; and processing the image data to detect the presence of the vehicle using the trained image processing model.
Embodiment 6. The system of embodiment 1, wherein detecting the presence of the object further comprises determining a state of a vehicle, wherein determining the state of the vehicle comprises: receiving data associated with the vehicle; and determining the state of the vehicle based on the data associated with the vehicle; and determining the control instruction comprises determining the control instruction based on the state of the vehicle.
Embodiment 7. The system of embodiment 1, wherein the operations further comprise: generating a notification based on the changed state of the movable barrier operator and the comparing; and transmitting the notification to a user device.
Embodiment 8. A method for affecting a state change of a movable barrier operator based on a concentration of one or more gases, the method comprising: receiving, by a processor communicatively connected to a movable barrier operator and a sensor, image data from an image capture device; processing, by the processor, the image data to detect a presence of a vehicle within a structure; receiving, by the processor, sensor data identifying a concentration of a gas within the structure; comparing, by the processor, the identified concentration of the gas with a concentration threshold; determining, by the processor, a current state of a movable barrier operator that is associated with the structure; determining, by the processor, a control instruction to change the state of the movable barrier operator in response to the comparison and the current state of the movable barrier operator; and causing, by the processor, communication of the control instruction to the movable barrier operator to change the state of the movable barrier operator.
Embodiment 9. The method of embodiment 8, wherein: detecting the presence of the vehicle further comprises determining a state of the vehicle; and determining the control instruction comprises determining the control instruction based on the state of the vehicle.
Embodiment 10. The method of embodiment 9, wherein: receiving the image data comprises receiving thermal image data from the image capture device; and processing the image data comprises processing the thermal image data to determine the state of the vehicle.
Embodiment 11. The method of embodiment 8, wherein: detecting the presence of the vehicle further comprises identifying an occupancy status of a vehicle based on the image data; and determining the control instruction comprises determining the control instruction based on the occupancy status of the vehicle.
Embodiment 12. The method of embodiment 8, wherein processing the image data comprises: training an image processing model using training data; and processing the image data to detect the presence of the vehicle using the trained image processing model.
Embodiment 13. The method of claim 8, wherein the method further comprises: generating, by the processor, a notification based on of the changed state of the movable barrier operator and the comparing; and transmitting the notification to a user device.
Embodiment 14. A computing system for changing a state of a movable barrier operator based on a concentration of one or more gases, the system comprising: a movable barrier operator associated with a structure; one or more processors communicatively connected to the movable barrier operator and a sensor; and one or more non-transitory computer-readable media that collectively store instructions that, when executed by the one or more processors, cause the computing system to perform operations, the operations comprising: receiving, at the processor, image data from an image capture device; processing the image data to determine a presence of a vehicle within the structure, wherein determining the presence of the vehicle further comprises determining a state of the vehicle, wherein processing the image data comprises: training an image processing model using training data; and processing the image data to detect the presence of the vehicle using the trained image processing model; receiving, at the processor, sensor data identifying a concentration of a gas within the structure; comparing, by the processor, the identified concentration of the gas with a concentration threshold; determining a current state of the movable barrier operator; determining a control instruction to change the state of the movable barrier operator in response to the comparing and the current state of the movable barrier operator; and causing communication of the control instruction to the movable barrier operator to change the state of the movable barrier operator.
Embodiment 15. The system of embodiment 14, wherein the operations further comprise: generating a notification based on the changed state of the movable barrier operator and the comparing; and transmitting the notification to a user device.
Embodiment 16. The system of embodiment 14, wherein receiving the image data comprises receiving thermal image data from the image capture device; and processing the image data comprises processing the thermal image data to determine the state of the vehicle.
Embodiment 17. The system of embodiment 14, wherein detecting the presence of the vehicle further comprises identifying an occupancy status of the vehicle based on the image data; and determining the control instruction comprises determining the control instruction based on the occupancy status of the vehicle.
Embodiment 18. The system of embodiment 17, wherein identifying the occupancy status of the vehicle further comprises identifying an operation history of at least one door associated with the vehicle.
Embodiment 19. The system of embodiment 14, wherein the image processing model comprises a machine learning model.
Embodiment 20. The system of embodiment 14, wherein determining the control instruction comprises: receiving a vehicle identifier associated with the vehicle; comparing the vehicle identifier to a reference database that comprises information associated with the vehicle; and determining a dimension associated with the vehicle based on the comparing; and modifying the control instruction based on the dimension.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A system for affecting a state change of a movable barrier operator based on a concentration of one or more gases, the system comprising:
a movable barrier operator associated with a structure, the movable barrier operator configured to move a movable barrier between a plurality of positions;
a computing system comprising:
a processor communicatively connected to the movable barrier operator and a sensor; and
a non-transitory computer-readable media that stores instructions that, when executed by the processor, causes the computing system to perform operations, the operations comprising:
detecting a presence of an object within the structure;
receiving, at the processor, sensor data identifying a concentration of a gas within the structure;
comparing, by the processor, the identified concentration of the gas with a concentration threshold;
determining a current state of the movable barrier operator;
determining a control instruction to change the state of the movable barrier operator in response to the comparing and the determined current state of the movable barrier operator; and
causing communication of the control instruction to the movable barrier operator to change the state of the movable barrier operator.

2. The system of claim 1, wherein detecting the presence of the object within the structure comprises detecting the presence of a vehicle within the structure, and wherein detecting the presence of the vehicle comprises:
receiving image data from an image capture device; and
processing the image data to detect the presence of the vehicle.

3. The system of claim 2, wherein:
detecting the presence of the vehicle further comprises detecting a state of the vehicle based on the image data; and
determining the control instruction comprises determining the control instruction based on the state of the vehicle.

4. The system of claim 2, wherein:
detecting the presence of the vehicle further comprises identifying an occupancy status of the vehicle based on the image data; and
determining the control instruction comprises determining the control instruction based on the occupancy status of the vehicle.

5. The system of claim 2, wherein processing the image data further comprises:
training an image processing model using training data; and
processing the image data to detect the presence of the vehicle using the trained image processing model.

6. The system of claim 1, wherein:
detecting the presence of the object further comprises determining a state of a vehicle, wherein determining the state of the vehicle comprises:
receiving data associated with the vehicle; and
determining the state of the vehicle based on the data associated with the vehicle; and
determining the control instruction comprises determining the control instruction based on the state of the vehicle.

7. The system of claim 1, wherein the operations further comprise:
generating a notification based on the changed state of the movable barrier operator and the comparing; and
transmitting the notification to a user device.

8. A method for affecting a state change of a movable barrier operator based on a concentration of one or more gases, the method comprising:
receiving, by a processor communicatively connected to a movable barrier operator and a sensor, data from a sensor;
processing, by the processor, the data to detect a presence of a vehicle within a structure;
receiving, by the processor, sensor data identifying a concentration of a gas within the structure;
comparing, by the processor, the identified concentration of the gas with a concentration threshold;
determining, by the processor, a current state of the movable barrier operator;
determining, by the processor, a control instruction to change the state of the movable barrier operator in response to the comparing and the current state of the movable barrier operator; and
causing, by the processor, communication of the control instruction to the movable barrier operator to change the state of the movable barrier operator.

9. The method of claim 8, wherein:
detecting the presence of the vehicle further comprises determining a state of the vehicle; and
determining the control instruction comprises determining the control instruction based on the state of the vehicle.

10. The method of claim 9, wherein:
receiving the data comprises receiving thermal image data from an image capture device; and
processing the data comprises processing the thermal image data to determine the state of the vehicle.

11. The method of claim 8, wherein:
detecting the presence of the vehicle further comprises identifying an occupancy status of a vehicle based on an image data captured by an image capture device at the structure; and
determining the control instruction comprises determining the control instruction based on the occupancy status of the vehicle.

12. The method of claim 8, wherein the received sensor data comprises a concentration of carbon monoxide in a monitored area of the structure, and wherein comparing comprises comparing the concentration of carbon monoxide to a carbon monoxide concentration threshold.

13. The method of claim 8, wherein the method further comprises:
generating, by the processor, a notification based on of the changed state of the movable barrier operator and the comparing; and
transmitting the notification to a user device.

14. A computing system for affecting a state change of a movable barrier operator based on a concentration of one or more gases, the system comprising:
a movable barrier operator associated with a structure;
a processor communicatively connected to the movable barrier operator and a sensor; and
a non-transitory computer-readable media that stores instructions that, when executed by the processor, causes the computing system to perform operations, the operations comprising:
receiving, at the processor, image data from an image capture device;
processing the image data to determine a presence of a vehicle within the structure, wherein determining the presence of the vehicle further comprises determining a state of the vehicle, wherein processing the image data comprises:
training an image processing model using training data; and
processing the image data to detect the presence of the vehicle using the trained image processing model;
receiving, at the processor, sensor data identifying a concentration of a gas within the structure;
comparing, by the processor, the identified concentration of the gas with a concentration threshold;
determining a current state of the movable barrier operator;
determining a control instruction to change the state of the movable barrier operator in response to the comparing and the current state of the movable barrier operator; and
causing communication of the control instruction to the movable barrier operator to change the state of the movable barrier operator.

15. The system of claim 14, wherein the operations further comprise:
generating a notification based on the changed state of the movable barrier operator and the comparing; and
transmitting the notification to a user device.

16. The system of claim 14, wherein:
receiving the image data comprises receiving thermal image data from the image capture device; and
processing the image data comprises processing the thermal image data to determine the state of the vehicle.

17. The system of claim 14, wherein:
detecting the presence of the vehicle further comprises identifying an occupancy status of the vehicle based on the image data; and
determining the control instruction comprises determining the control instruction based on the occupancy status of the vehicle.

18. The system of claim 17, wherein identifying the occupancy status of the vehicle further comprises identifying an operation history of at least one door associated with the vehicle.

19. The system of claim 14, wherein the image processing model comprises a machine learning model.

20. The system of claim 14, wherein determining the control instruction comprises:
receiving a vehicle identifier associated with the vehicle;
comparing the vehicle identifier to a reference database that comprises information associated with the vehicle; and
determining a dimension associated with the vehicle based on the comparing; and
modifying the control instruction based on the dimension.
